(19) United States
(12) Patent Application Publication
(10) Pub. No.: US 2026/0308439 A1
(43) Pub. Date: Oct. 8, 2026

(54) DRILLING MUD AND METHOD OF MAKING DRILLING MUD HAVING AN UNREFINED PETROLEUM PRODUCT

(71) Applicant: 4 Oaks Solutions LLC, Calumet, OK (US)

(72) Inventors: Vernon Gassen, Calumet, OK (US); Terry Cronin, Calumet, OK (US)

(21) Appl. No.: 19/573,770

(22) Filed: Mar. 20, 2026

Related U.S. Application Data
(60) Provisional application No. 63/775,583, filed on Mar. 21, 2025.

(51) Int. Cl. C09K 8/36; E21B 21/06

(52) U.S. Cl. CPC C09K 8/36; E21B 21/062

(57) ABSTRACT

Drilling muds and methods of manufacture are described herein. The drilling mud may comprise a continuous phase being a blend of at least two unrefined petroleum products including a first unrefined petroleum product and a second unrefined petroleum product. A dispersed phase may be dispersed throughout the continuous phase. The first unrefined petroleum product and second unrefined petroleum product may have API gravities in a range of 28 to 45, and the continuous phase may have an API gravity in a range of 32 to 42. The drilling mud may be made by blending a first unrefined petroleum product and a second unrefined petroleum product to achieve a target continuous phase API gravity, and dispersing a dispersed phase throughout the continuous phase. One or more drilling mud additives may be blended into the continuous phase to form a drilling mud.

### CROSS REFERENCE TO RELATED APPLICATIONS

This application claims priority to U.S. Provisional Application No. 63/775,583, filed Mar. 21, 2025, the entire contents of which is hereby expressly incorporated herein by reference.

### BACKGROUND

The drilling of a wellbore is typically carried out using a steel pipe known as a drill string with a drill bit disposed at the lowermost end. As the drill bit is rotated, it cuts through a subterranean formation forming a wellbore. The entire drill string may be rotated using an over-ground drilling motor, or the drill bit may be rotated independently of the drill string using a fluid powered motor or motors mounted in the drill string just above the drill bit. As drilling progresses, a flow of drilling mud is typically pumped through an inlet line down the drill string and passed over, through, and around the drill bit, returning to the surface via the annulus between the outer wall of the drill string and the wellbore.

Drilling mud may serve several purposes. In some implementations, mud may permit tighter control of a well by exerting hydrostatic pressure through the mud column of an open hole formation, offsetting increases in formation pressure that could otherwise force formation fluids into the borehole. Drilling mud may also be used to remove cuttings (e.g. rock fragments) created by the drill bit by carrying the fragments to the surface. Additionally, hydraulic energy transmitted through the discharge of mud through nozzles at the face of the bit loosens the downhole formation and assists in drilling. Lastly, the presence of mud in and around the drilling bit cools and lubricates the bit, extending the lifespan of the bit.

Drilling mud generally comprises a continuous-phase formed of either a water or oil base, and a dispersed phase suspended within the continuous phases formed of oil or water. Oil-in-water muds are typically termed “conventional” emulsions, while water-in-oil muds are typically termed “invert” emulsions. While conventional emulsions are relatively economical and environmentally friendly, invert emulsions typically offer improved performance and durability in challenging formations and high temperatures. These oil-based muds are commonly comprised of diesel and offer improved penetration rates, improved well bore integrity, enhanced lubricity, improved temperature balance, and other performance improvements over water-based muds.

Despite the performance improvements of diesel muds over water-based muds, diesel muds are challenging and expensive to process, reuse, recycle, and/or dispose of. Diesel muds commonly exhibit foaming during the blending process, increasing time and cost to manufacture. Diesel-based continuous phases further often have rheological properties which increase sag, or the tendency of suspended materials to settle out of the liquid. Thus, the mixing process often requires a degree of “shearing” by cycling the diesel through drill nozzles, thinning out the continuous-phase and thereby decreasing sag and increasing miscibility. Moreover, as prices of refined products continue to increase, the manufacturing cost of diesel muds has become increasingly more expensive and, in turn, the cost of drilling with diesel muds has increased.

Therefore, there exists a need for an oil-based mud of comparable or improved performance to diesel muds while reducing the economic burden and difficulty of manufacturing the mud. It is to such a drilling mud that the present disclosure is directed.

### SUMMARY

A drilling mud and method of making are disclosed. The prior art problem of diesel-based drilling mud manufacturing posing significant economic burden is addressed through a mud having a continuous phase comprising a blend of one or more unrefined petroleum product and a refined petroleum product at a particular API gravity, or a blend of two or more unrefined petroleum products without a refined petroleum product at a particular API gravity.

As used herein, “unrefined petroleum products” may comprise any raw petroleum products which have not undergone chemical processing to become a final, commonly-usable product. This can include wellhead products such as crude oils, knockout products such as processing condensates and natural gas liquids, recycled petroleum products, and petroleum waste products.

A drilling mud in accordance with this disclosure may comprise a continuous phase, a dispersed phase, and at least one mud additive. The continuous phase may comprise a first unrefined petroleum product and a second unrefined petroleum product. The dispersed phase may be dispersed within the continuous phase as an emulsion and may comprise water. The at least one mud additive may be an emulsifier, a weighting agent, a loss circulation material, a filtration control additive, lime, or a lubrication agent. In one implementation, the continuous phase may be 90% to 95% of the volume of the drilling mud. In another implementation, the continuous phase may be 60% to 90% of the volume of the drilling mud.

The first unrefined petroleum product and second unrefined petroleum product may have an API gravity in a range of 26 to 60, more specifically 28 to 45 when measured at a selected temperature, such as 60 degrees Fahrenheit. When combined, the continuous phase may have an API gravity of between 34 and 36 when measured at a selected temperature, such as 60 degrees Fahrenheit or between 41 and 43 when measured at the selected temperature. Preferably, the continuous phase may have an API gravity of 35 or 42 when measured at the selected temperature.

A method of producing the drilling mud comprises blending a first unrefined petroleum product and a second unrefined petroleum product to form a continuous phase having an API gravity API gravity within a range selected from the group consisting of: 34 to 36, measured at 60 degrees Fahrenheit; and 41 to 43, measured at 60 degrees Fahrenheit; and dispersing a dispersed phase into the continuous phase. One or both of the volumes of the first unrefined petroleum product and second unrefined petroleum product may be adjusted according to their respective API gravities and the desired API gravity of the continuous phase. Additives may be added to the blend to form a drilling mud.

The foregoing summary provides an overview of certain selected implementations or embodiments disclosed herein, and is not intended to describe every aspect, embodiment, implementation, feature, or advantage of the disclosure exhaustively or comprehensively. Therefore, this summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a drawing depicting a drilling system in accordance with the present disclosure.

FIG. 2 is a drawing depicting constituents of a drilling mud composed in accordance with the present disclosure.

FIG. 3 is a flow diagram depicting an implementation of a process for making drilling mud in accordance with the present disclosure.

FIG. 4 is a flow diagram depicting another implementation of a process for making drilling mud in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set a lower and an upper boundary of a range in accordance with the embodiments of the present disclosure.

An “unrefined petroleum product” will be understood to include raw or minimally-processed crude oils or any blend thereof, natural bitumen, oil sands, and heavy fuel residues from extraction. Minimally-processed crude oils will be understood to include stabilized crude oils, field-processed crude oils, treated crude oils, and partially-processed crude oils. For example, crude oils that have undergone basic treatment such as light gas removal, dehydration, and/or desalting will be understood to be “unrefined petroleum product” for the purposes of this disclosure.

Finally, as used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

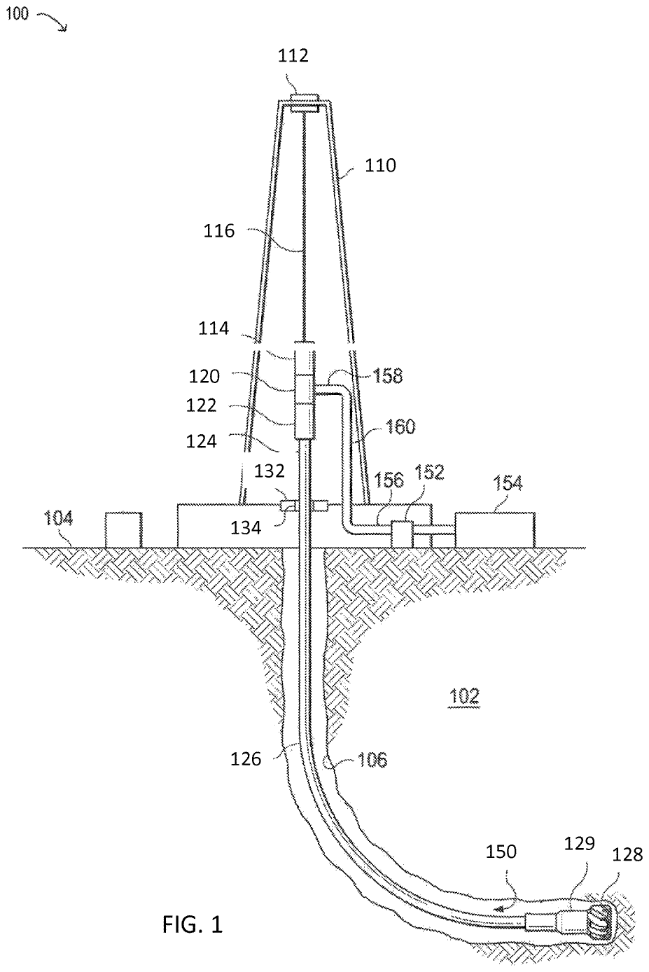

Referring now to the drawings, an example of a drilling system 100 according to the present invention is shown in FIG. 1. The drilling system 100 may comprise a derrick 110. The derrick 110 may comprise a crown block 112 to which a traveling block 114 is coupled via a drilling line 116. In drilling system 100, a top drive 120 may be coupled to traveling block 114 and may provide rotational force for drilling. A saver sub 122 may sit between the top drive 120 and a drill pipe 124 that is part of a drill string 126. Top drive 120 may rotate drill string 126 via the saver sub 122, which in turn may rotate a drill bit 128 of a bottom hole assembly 129 in borehole 106 passing through formation 102. Also visible in drilling system 100 is a rotary table 132 that may be fitted with a master bushing 134 to hold drill string 126 when not rotating. In some embodiments, the bottom hole assembly 129 may include a mud motor coupled to the drill bit 128 and operable to rotate the drill bit 128.

Drilling system 100 may comprise a system for circulating drilling mud 150 through formation 102. A mud pump 152 may direct drilling mud 150 from a mud pit 154 into drill string 126. Although mud pit 154 is shown schematically as a container, it is noted that various receptacles, tanks, pits, or other containers may be used. Drilling mud 150 may flow from mud pump 152 into a discharge line 156 that is coupled to a rotary hose 158 by a standpipe 160. Rotary hose 158 may then be coupled to top drive 120, which includes a passage for drilling mud 150 to flow into borehole 106 via drill string 126 from where drilling mud 150 may emerge at drill bit 128. Drilling mud 150 may lubricate drill bit 128 during drilling and, due to the pressure supplied by mud pump 152, drilling mud 150 may return via borehole 106 to surface 104.

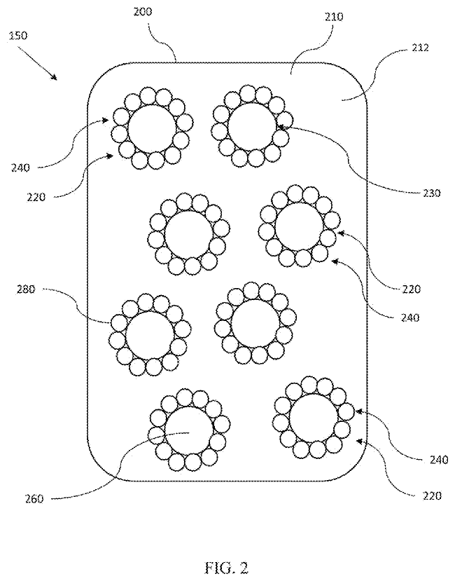

FIG. 2 is an exemplary drawing of general constituents of the drilling mud 150. The drilling mud 150 may be a colloidal mixture comprising a 1) continuous phase 200 having an oil base 210 and 2) a dispersed phase 220 dispersed throughout the continuous phase 200. The dispersed phase 220 may have an aqueous base, such as water or a brine comprised of salt-rich water. In some implementations, drilling mud 150 may be an emulsion. In such an implementation, the dispersed phase 220 may comprise a plurality of micelles 240 each comprising an aqueous droplet 260 and emulsifier 280. Emulsifier 280 may completely surround the aqueous droplet 260 and assist with keeping the aqueous droplet 260 suspended within the continuous phase 200.

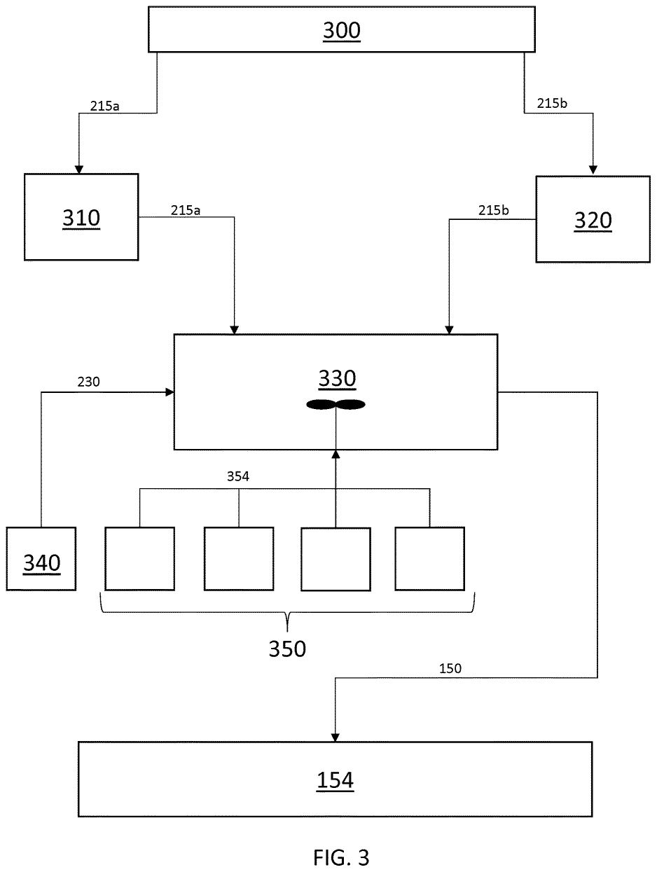

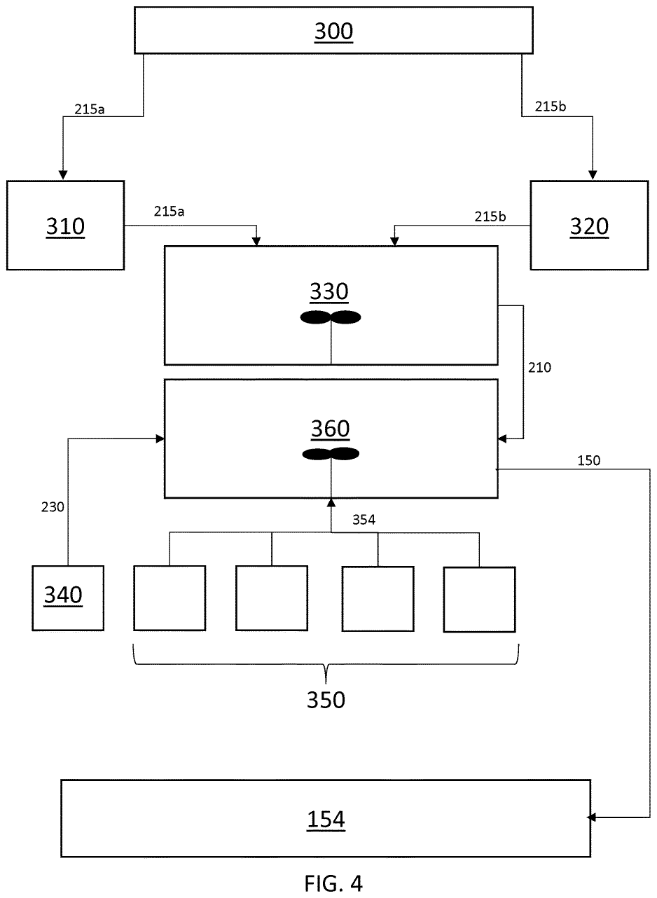

The oil base 210 of continuous phase 200 may be a blended petroleum product 212 having one or more constituents 215a . . . n (FIGS. 3, 4). The oil base 210 may therefore be formulated by blending, mixing, and/or combining one or more constituents 215a . . . n with one or more other constituents 215a . . . n.

In some implementations, the one or more constituents 215a . . . n may be one or more unrefined petroleum products or a blend thereof, one or more refined petroleum products or a blend thereof, or one or more blended unrefined and refined petroleum products. For example, the one or more constituents 215a . . . n may be two or more unrefined petroleum products, two or more refined petroleum products, or a combination of at least one unrefined petroleum product and at least one refined petroleum product Exemplary refined petroleum products include gasoline, diesel, kerosene and the like. Unrefined petroleum products may be from any source, of any type, and of any constitution and composition.

The one or more constituents 215a . . . n may have a particular API gravity. For example, in some implementations, unrefined petroleum products may have an American Petroleum Institute gravity (API gravity) in a range of 28 and 45. Wherein the constituents 215a . . . n comprise two or more unrefined petroleum products, the two or more unrefined petroleum products may be blended in varying amounts such that the oil base 210 has a desired API gravity at a selected temperature, such as 60 degrees Fahrenheit. In one implementation, the two or more unrefined petroleum products may be blended such that the oil base 210 has an API gravity (at the selected temperature) of 31 to 43, preferably 33 to 37, more preferably 34 to 36, and most preferably 35. In another implementation, the two or more unrefined petroleum products may be blended such that the oil base 210 has an API gravity (at the selected temperature) of 31 to 43, preferably 40 to 44, more preferably 41 to 43, and most preferably 42.

The API gravity of the oil base 210 is critical to the performance of the drilling mud 150. Generally, a higher API gravity may be preferred because the pour point of the oil base 210 decreases as API gravity increases. Therefore, the oil base 210 and thus the drilling mud 150 because easier to pump and control at higher API gravity. However, higher API gravity also decreases the flash point of the oil base 210, thereby increasing the risk for ignition. Thus, the API gravity should be in a range such that the drilling mud 150 is pumpable without unreasonable risk of ignition. In some implementations, it may be desirable that the oil base 210 have an API gravity near 42 in colder conditions, such as in winter, and near 35 in warmer conditions, such as in summer. In some implementations, ambient temperatures above 45 degrees Fahrenheit may be suitable for lower API gravity, such as 32 to 36, and ambient temperatures below 45 degrees Fahrenheit may be suitable for higher API gravities, such as 40 to 44.

Unrefined petroleum products within a range of API gravity of 34 to 36 at the desired temperature may be classified as “medium” unrefined petroleum products. Medium unrefined petroleum products offer a balance of properties that are highly advantageous in many drilling scenarios. Unrefined petroleum products within the range of API gravity 34 to 36 provide a viscosity that facilitates efficient cuttings transport and hole cleaning, while minimizing excessive drag and pressure losses; contribute to effective fluid loss control, prevent excessive filtrate invasion into the formation; exhibit good thermal stability, maintain the properties of the unrefined petroleum product under the high temperatures encountered in deep drilling; and offer a good balance of cost and performance.

Unrefined petroleum products within a range of API gravity 41 to 43 at the desired temperature may be classified as “light” unrefined petroleum products. Light unrefined petroleum products are less dense and more fluid than medium unrefined petroleum products. Light unrefined petroleum products also offer a balance of properties that are highly advantageous in many drilling scenarios when ambient temperatures at the Earth's surface exceed 45 degrees Fahrenheit and are generally within a range of 45 degrees to 120 degrees. Unrefined petroleum products within the range of API gravity 41 to 43 provide a lower density resulting in a reduced hydrostatic pressure gradient, which is beneficial in formations with lower fracture gradients; contribute to increased penetration rates, improving drilling efficiency; minimize formation damage due to their reduced potential for filtrate invasion; and provide enhanced performance in specific well conditions.

In some implementations, the drilling mud 150 may comprise 90% or greater by volume of continuous phase 200, and up to 10% by volume of dispersed phase 220. In some implementations, the drilling mud 150 may comprise 90% to 95% by volume of continuous phase 200 and 5% to 10% by volume of dispersed phase 220. In some implementations, drilling mud 150 may comprise 50% to 95% by volume of the continuous phase and 5% to 50% by volume of the dispersed phase 220.

FIG. 3 illustrates a process for making drilling mud 150 according to the present disclosure. Constituents 215a . . . n, which may be unrefined petroleum products, refined petroleum products, or both may be received from source 300. Source 300 may be one or a plurality of sources 300. A first constituent 215a, which may be a first unrefined petroleum product, may be received from source 300 and stored in first constituent tank 310. A second constituent 215b, which may be a second unrefined petroleum product, may be received from source 300 and stored in a second constituent tank 320. First constituent tank 310 and second constituent tank 320 may comprise mixing apparatuses (not shown) to keep liquid products homogenous.

An API gravity of the first constituent 215a and second constituent 215b may be previously measured or known prior to receipt. In some implementations, constituents 215a . . . n outside of the preferred API gravity range of 28 to 45 may be rejected prior to receipt. In other implementations, the API gravities of the constituents 215a . . . n may be measured subsequent to receipt, such as subsequent to storage of the first constituent 215a in the first constituent tank 310 and the second constituent 215b in the second constituent tank 320. In such implementation, the API gravity may be measured by any tank gauging method known to one of skill in the art. In one implementation, this may be done by taking samples from the first constituent tank 310 and second constituent tank 320 and measuring the API gravity of each with a hydrometer. In another implementations, a hydrometer may be part of an automatic tank gauging mechanism. In such an implementation, API gravity or specific gravity may be visible through a sight glass or displayed onto a digital display.

An API gravity of the first constituent 215a and second constituent 215b may be in a range of 28 to 45. If either the first constituent 215a or second constituent 215b has an API gravity outside of this range, they may not be used in this process and a replacement constituent 215c . . . n may be obtained. Once the API gravities of the first constituent 215a and second constituent 215b are known, a volume of each constituent 215a,b to be blended may be calculated according to a known target blend volume and target blend API gravity.

In one implementation, a target API gravity may be 33 to 37; preferably 34 to 36; most preferably 35. In another implementation, a target API gravity may be 40 to 44; preferably 41 to 43; most preferably 42.

Where one or more of the constituents 215a . . . n comprise unrefined petroleum products the selection of unrefined petroleum products for the blend is based on the individual API gravities and other relevant properties, such as viscosity, pour point, and sulfur content. Precise blending ratios may be determined through laboratory testing to achieve the desired API gravity within the specified ranges. The blending process ensures homogeneity and stability of the continuous phase 200 so as to prevent phase separation and maintain consistent properties throughout the drilling operation.

The source of the unrefined petroleum products is also a consideration. Unrefined petroleum product from different regions of the world will contain differing levels of various chemical compounds. This must be taken into account when producing the blend.

By precisely controlling the API gravity of the continuous phase base fluid 200, the drilling mud 150 optimizes drilling performance, minimizes operational risks, and enhances overall well productivity. Selecting between the medium and light unrefined petroleum product ranges provides flexibility to adapt to diverse drilling conditions and formation characteristics.

The dispersed phase 220 in the drilling mud 150 refers to liquid or solid particles that are suspended within the continuous phase base fluid (the unrefined petroleum product blend). Liquid particles in the dispersed phase 220 may be referred to as an “emulsion”. The solid particles can include weighting agents, drilled solids, loss circulation material, and other solids.

The weighting agents (high-density material) including but not limited to barite, and hematite are added to increase the mud's density. The weighting agents are selected and blended to provide sufficient hydrostatic pressure to prevent formation fluids from entering the wellbore, thus preventing blowouts. The weighting agents increase the overall density of the mud, creating a higher pressure gradient than the formation pressure.

Drilled solids are fragments of rock and formation materials that are generated during the drilling process. The drilled solids are carried out of the borehole 106 by circulating the drilling mud 150. The viscosity of the drilling mud 150 is designed to effectively suspend and transport these solids to the surface.

Loss circulation materials may be of various sizes and shapes that are added to the drilling mud 150 to seal fractures or porous zones in the formation 102, preventing the loss of drilling fluid.

The other solids may include polymers, clays, and other additives that are added to modify the mud's properties.

When the dispersed phase 220 includes liquid to form an emulsion, the liquid particles may be water droplets dispersed within the continuous phase 200 to form an oil-in-water emulsion. The oil in water emulsion serves a variety of purposes, such as controlling the rheological properties (viscosity, gel strength) of the drilling mud 150; providing cooling and lubrication; reducing the overall cost of the drilling mud 150, and aiding in electrical stability of the drilling mud 150. The dispersed water droplets contribute to the viscosity and flow behavior of the drilling mud, and help cool the drill string 126 and reduce friction between the drill string 126 and the borehole 106. The drilling mud may also be provided with the dispersed phase 220 in the form of emulsifiers. Emulsifiers stabilize the emulsion, preventing the water droplets from coalescing, and reducing the interfacial tension between the oil and water phases, creating a stable dispersion. Emulsifiers maintain the stability of the drilling mud 150 under high temperatures and pressures.

The dispersed phase 220 works in conjunction with the continuous phase 200 to create the drilling mud 150.mb

An example of a blending calculation is as follows. Suppose a first constituent 215a has an API gravity of 28, and a second constituent 215b has an API gravity of 42. It is desired to produce 100 barrels of oil base 210 having an API gravity of 35. The following equations may be used:

$${V}_{1} = \frac{{API}_{blend} \times {V}_{total} - {V}_{total} \times {API}_{2}}{{API}_{1} - {API}_{2}} \qquad Eq . 1$$

$${V}_{2} = {V}_{total} - {V}_{1} \qquad Eq . 2$$

where API_{blend} is the target API gravity of 35, API₁ is the first constituent 215a API gravity of 28, API₂ is the second constituent 215b API gravity of 42, and Vₜₒₜₐₗ is the total desired volume of 100 barrels. Using the values in Eq. 1, shows that 50 barrels of the first constituent 215a is required. Using this result with Eq. 2, shows that 50 barrels of second constituent 215b is also required.

Returning to FIG. 3, the calculated volumes of first constituent 215a and second constituent 215b may be pumped or otherwise placed into a mixer 330. Mixer 330 may be any process mixer known to one of skill in the art capable of creating a homogenous mixture of the two volumes of constituents 215a, b.

The mixer 330 may first blend only the two constituents 215a and 215b until a blended petroleum product 212 is obtained. Then, one or more additions may be made to the mixer 330. In some implementations, water 230 from a water source 340 may be added to the mixer 330 to form a dispersed phase 220 within the continuous phase 200. In some implementations, one or more additives 354 may be added to the mixer 330 from additive tanks 350. Additive tanks 350 may be a plurality of storage vessels storing mud additives such as emulsifiers, weighting agents, loss circulation materials, filtration control additives, lime, and lubrication agents. The mixer 330 may be allowed to run until a drilling mud mixture is sufficiently blended.

In another implementation, shown in FIG. 4, a plurality of mixers may be used. In this implementation, the first mixer 330 may be used to blend the first constituent 215a and the second constituent 215b to produce the oil base 210. The oil base 210 may exit the first mixer 330 and enter a second mixer 360, where the oil base 210 may be blended with water 230 and/or one or more additives 354.

Subsequent to sufficient blending of constituents 215a, b as well as blending any water 230, and additives 354, a blended drilling mud 150 is produced. Drilling mud 150 may be pumped via a mud pump to mud pits 154 for use in the drilling system 100.

Any number of mixers may be used in accordance with the present disclosure. The additive 354, the water 230, the first constituent 215a, the second constituent 215b, or the oil base 210 may be blended separately or in combination with the components in any number of mixers. For example, additives 354 may be blended together in a mixer prior to being blended with the oil base 210. In another example, water 230 may be blended with the oil base 210 in one mixer, and the resulting emulsion may then be blended with the additives 354 in another mixer. Alternatively, components may be blended sequentially in the same mixer by introducing the components at separate instants of times.

Further, though only two constituents 215a, b and two constituent tanks 310, 320 are shown in FIGS. 3 and 4, it should be understood that any number of constituents 215a . . . n may be utilized in this process. In some implementations, this process may comprise blending three or more constituents 215a . . . n. For example, a first constituent 215a, a second constituent 215b, a third constituent 215c, a fourth constituent 215d, and so forth up to a nth constituent 215n may be blended to form the oil base 210. In such an implementation, any or all of the constituents 215a . . . n may be unrefined petroleum product, refined petroleum product, or a blend of unrefined petroleum product and refined petroleum product.

The drilling mud disclosed above offers increased rheology over prior art muds. It is desirable for a drilling mud to have a 6-rpm dial reading from a viscometer such as a Fann viscometer of between 8-12. In prior art diesel-based muds, a 6-rpm dial reading may produce readings only between 2 and 8. The diesel muds would thus require significant downhole shearing and temperature cycles to increase rheological properties. With the blended petroleum product of the present disclosure, a 6-rpm dial reading may be within the desired range of 8 to 12 and often is even higher, such as 13. The blended petroleum product may therefore exhibit high performance immediately as opposed to prior art muds requiring significant downhole shearing and temperature cycles.

Further, the drilling mud disclosed above may require less blending time over prior art diesel muds. The unrefined petroleum product blending process may take as little as an hour, whereas significant foaming of prior art blends causes mixing times to take as long as three hours.

### CONCLUSION

An oil-based drilling mud and method of making are provided herein. The drilling mud comprises an oil-based continuous phase comprising a blend of at least one unrefined petroleum product and optionally a refined petroleum product. The use of a blend of two or more unrefined petroleum products, for example, as a continuous phase in a drilling mud offers numerous benefits over prior art attempts. Observations of improvements include less residual build up, reduced blending times, tighter emulsions, increased rheology, and competitive cost. Additionally, the present disclosure describes methods for precise API gravity control for drilling mud 150 through unrefined petroleum product blending techniques. In some embodiments, the present methodologies for making the drilling mud 150, and the drilling mud 150 provide deliberate and precise manipulation of the continuous phase base fluid's API gravity through a specific blend of at least two unrefined petroleum products.

The ability to consistently achieve and maintain API gravities within the ranges of 34-36 or 41-43, measured at 60 degrees Fahrenheit, provides a level of control and performance that is not readily achievable with conventional methods.

The API gravity 34-36 range for the drilling mud 150 offers a balance of viscosity, fluid loss control, and thermal stability, suitable for a wide range of drilling operations. The API gravity 41-43 range provides reduced hydrostatic pressure and enhanced penetration rates, ideal for formations with lower fracture gradients. The ability to select between two distinct API gravity ranges allows operators to easily adjust the properties of the drilling mud 150 to meet the specific requirements of each well.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A drilling mud comprising:
a continuous phase, the continuous phase comprising a blend of a first unrefined petroleum product having a first API gravity and a second unrefined petroleum product having a second API gravity;
a dispersed phase dispersed within the continuous phase;
at least one mud additive; and
wherein the continuous phase has a combined API gravity in a range of 31 to 43 measured at a selected temperature.

2. The drilling mud of claim 1 wherein the dispersed phase comprises water.

3. The drilling mud of claim 1 wherein the at least one mud additive is selected for a group consisting of: an emulsifier; a weighting agent; a loss circulation material; a filtration control additive; a lime; a lubrication agent; and combinations thereof.

4. The drilling mud of claim 1 wherein the range is a first range, and wherein the first API gravity and the second API gravity are in a second range of 28 to 45.

5. The drilling mud of claim 1 wherein the range is a first range, and wherein the combined API gravity is in a second range of 34 to 36.

6. The drilling mud of claim 1 wherein the range is a first range, and wherein the combined API gravity is in a second range of 41 to 43.

7. The drilling mud of claim 1 wherein the drilling mud has a volume, and the continuous phase is 90% to 95% of the volume of the drilling mud.

8. The drilling mud of claim 1 wherein the drilling mud has a volume, and the continuous phase is 50% to 95% of the volume of the drilling mud.

9. A continuous phase component for a drilling mud comprising:
a blend of at least two unrefined petroleum products, with each unrefined petroleum product having a first API gravity in a first range of 28 to 45;
wherein the blend of the at least two unrefined petroleum products is formulated to achieve an API gravity within a range selected from the group consisting of:
34 to 36, measured at 60 degrees Fahrenheit; and
41 to 43, measured at 60 degrees Fahrenheit.

10. A method comprising:
blending two or more constituents together, the two or more constituents comprising a first constituent and a second constituent, the first constituent including a first unrefined petroleum product having a first volume and a first API gravity, and the second constituent having a second volume and a second API gravity to form a continuous phase; and
dispersing a dispersed phase into the continuous phase to form a drilling mud.

11. The method of claim 10, wherein the second constituent is a second unrefined petroleum product.

12. The method of claim 10, wherein the second constituent is a refined petroleum product.

13. The method of claim 10 where the continuous phase has an API gravity, and further comprising adjusting at least one of the first volume and the second volume such that the API gravity of the continuous phase is in a range of 31 to 43 at a selected temperature.

14. The method of claim 11 where the API gravity of the continuous phase is in a range of 33 to 35 at a selected temperature.

15. The method of claim 11 where the API gravity of the continuous phase is in a range of 41 to 43 at a selected temperature.

16. The method of claim 10 where the dispersed phase is water.

17. The method of claim 10 further comprising blending at least one additive with the drilling mud.

18. The method of claim 15 wherein the at least one mud additive is selected from a group consisting of:
an emulsifier;
a weighting agent;
a loss circulation material;
a filtration control additive;
lime; and
a lubrication agent.
